(19) United States
(12) Patent Application Publication
(10) Pub. No.: US 2004/0233473 A1
(43) Pub. Date: Nov. 25, 2004

(54) Data processing apparatus and data processing method

(75) Inventors: Masaya Hashimoto, Amagasaki-shi (JP); Takeshi Morikawa, Takarazuka-shi (JP); Nobuo Kamei, Amagasaki-shi (JP); Daisuke Sakiyama, Maizuru-shi (JP)

Correspondence Address: Barry E. Bretschneider, Morrison & Foerster LLP, Suite 300, 1650 Tysons Boulevard, McLean, VA, 22102, US

(73) Assignee: Konica Minolta Business Technologies, Inc., Chiyoda-ku (JP)

(21) Appl. No.: 10/801,568

(22) Filed: Mar. 17, 2004

(30) Foreign Application Priority Data
May 20, 2003 (JP) 2003-154858

(51) Int. Cl. G06F 15/00; H04N 1/64; H04N 1/41; G06T 9/00; G06F 13/00

(52) U.S. Cl. 358/1.15; 358/539; 358/426.04; 358/426.05; 358/426.06; 382/239

(57) ABSTRACT

A data processing apparatus is provided with a compressor which compresses inputted job data every block, a memory which stores the compressed data every block, and a controller which sets a size of the block of the data to be compressed every block by the compressor depending on the attribute of the data.

Priority is claimed to Japanese Patent Application No. 2003-154858, filed on May 30, 2003, the disclosure of which is incorporated by reference in its entirety.

### BACKGROUND OF THE INVENTION

1. Field of the Invention

The present invention relates to a data processing apparatus and a data processing method for use in MFPs (Multi Function Peripherals) having a plurality of functions such as a copy function, a printer function, a scanner function and a facsimile function.

2. Description of Related Art

The following description sets forth the inventor's knowledge of related art and problems therein and should not be construed as an admission of knowledge in the prior art.

MFPs as mentioned above are provided with a plurality of input means for executing the aforementioned multiple functions. The examples of such input means include a receiving portion for receiving a print job transmitted from an external apparatus such as a personal computer via a network, a receiving portion for receiving a facsimile (FAX) job transmitted from an external apparatus such as a FAX apparatus via a communication line network, and an original reading portion for reading images of originals.

Such MFPs are further provided with a printer portion for printing, for example, the image data read by the aforementioned original reading portion or the print data transmitted from the aforementioned external apparatus. Furthermore, the MFPs are provided with a file memory for storing data inputted from each inputting means.

For the purpose of decreasing the capacity of the data that can be stored in the file memory, in general, a compressing device for compressing data is provided. The inputted data is transferred to the compressing device to be compressed and then stored in the file memory.

Conventionally, the data compressing operation by such compressing device is performed every divisional unit which is a unit having a smaller size obtained by dividing the data inputted per page unit by plural numbers, regardless of the attribution of the data to be compressed, e.g., color data or monochrome data. The compressed data of each divisional unit is stored every divisional unit in the file memory using necessary arrays, each array being a memory area having a certain size.

The inputted data is compressed and stored in a memory every divisional unit because of the following merits. In cases where a plurality of compressing devices are provided, only one of the compressing devices can be utilized if the data is not divided, but all of the compressing devices can be utilized if the data is divided. Furthermore, if the data is not divided, only after completion of the compressing operation of one page data, the subsequent processing can be executed. However, when the data is divided, even after completion of the compressing operation of one divisional unit data in the sub-scanning direction, the subsequent processing can be executed.

On the other hand, in cases where one page data is divided into plural divisional units to be compressed and stored, each compressed data will be stored in a file memory in a state in which a management table is attached to each divisional unit. This causes an increased total amount of data to be stored in the file memory by the data amount of the management tables, thus increasing the data size per one page, which in turn decreases the number of images/pages that can be stored in the file memory.

Especially, like monochrome data or binary data, in cases where the data amount per page is smaller than that of color data or multi-valued data, the data amount increasing ratio due to the attached management tables increases. Accordingly, the aforementioned drawbacks become conspicuous.

Regarding the data dividing processing, Japanese Unexamined Laid-open Patent Publication H6-297783 discloses that a print image is divided into plural divisional images and that an area required to develop these divisional images is managed by a simple method to thereby effectively utilize a storing area.

Furthermore, Japanese Unexamined Laid-open Patent Publication No. 2001-146047 discloses that a height of a dividing band is controlled based on an anticipated rendering required time of each band.

Japanese Unexamined Laid-open Patent Publication No. 2000-238349 discloses that each height of a page dividing band is optimally adjusted to thereby improve the image developing efficiency.

However, the aforementioned documents failed to solve the drawbacks in the case of monochrome data that the number of pages/images that can be stored in a file memory decreases when the data is divided into plural divisional units to be compressed and then stored in the file memory.

The description herein of advantages and disadvantages of various features, embodiments, methods, and apparatus disclosed in other publications is in no way intended to limit the present invention. Indeed, certain features of the present invention may be capable of overcoming certain disadvantages, while still retaining some or all of the features, embodiments, methods, and apparatus disclosed therein.

### SUMMARY OF THE INVENTION

It is an object of the present invention to provide a data processing apparatus capable of increasing the number of images/pages to be stored in a memory depending on the data attribute in the case of monochrome data for example.

It is an object of the present invention to provide a data processing method capable of increasing the number of images/pages to be stored in a memory depending on the data attribute.

According to a first aspect of the present invention, a data processing apparatus includes:

a compressor which compresses inputted job data every block into compressed data;

a memory which stores the compressed data every block; and

a controller which sets a size of the block of the data to be compressed every block by the compressor depending on an attribute of the data.

According to the second aspect of the present invention, a data processing method includes the steps of:

setting a size of a block of data to be compressed every block by a compressor depending on an attribute of the data;

compressing data of an inputted job into the set size of the block by the compressor; and

storing the compressed data into a memory every block.

Other objects and the features will be apparent from the following detailed description of the present invention with reference to the attached drawings.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspects or features of other embodiments where applicable. The descriptions of aspects, features and/or advantages of particular embodiments should not be construed as limiting other embodiments or the claims.

### BRIEF DESCRIPTION OF THE DRAWINGS

The accompanying figures are provided by way of example, without limiting the broad scope of the present invention or various other embodiments, wherein:

FIG. 1 is a block diagram showing the structure of a data processing apparatus according to an embodiment of the present invention;

FIG. 2 is a flowchart showing the contents of the compressing operation processing of the compressing/expanding devices in the data processing apparatus shown in FIG. 1;

FIG. 3 is a flowchart showing the contents of the compressing operation processing of the compressing/expanding devices according to another embodiment.

### DETAILED DESCRIPTION OF THE PREFERRED EMBODIMENTS

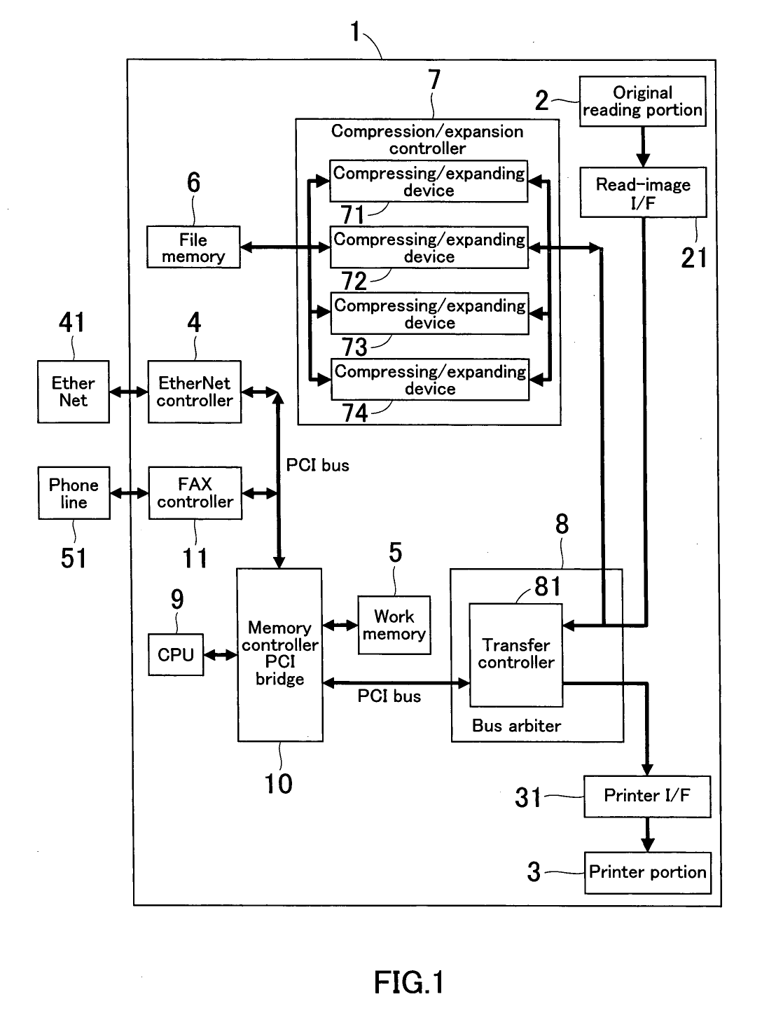

FIG. 1 shows a block diagram of a MFP1 as a data processing apparatus according to an embodiment of the present invention.

This data processing apparatus is provided with a plurality of input means and a plurality of output means. In detail, this apparatus is provided with an original reading portion 2 as input means, a printer portion 3 as output means, an EtherNet controller 4 which functions as both input means and output means, and a FAX controller 11 which also functions as both input means and output means.

The original reading portion 2 is provided with a scanner for reading out an image of an original, and the image data read out from the original is sent to a bus arbiter 8 via a read-image interface 21 (IR IMAGE I/F in FIG. 1). The printer portion 3 prints the image data transferred from the bus arbiter 8 on a paper or the like via the printer interface (printer I/F in FIG. 1).

The EtherNet controller 4 receives/transmits jobs via an EtherNet 41. For example, the EtherNet controller 4 receives a print job or an internet FAX (IFAX) job transmitted from an external device such as a personal computer (not shown) or an IFAX device via the Ethernet 41, or transmits the image data of the original read by the original reading portion 2 to an external device via the EtherNet 41.

The FAX controller 11 receives/transmits a FAX job between an external FAX device (not shown) and the MFP1 via a phone line 51. For example, the FAX controller 11 receives a FAX job transmitted from an external FAX device (not shown) via the phone line 51 or faxes the original image data read by the original reading portion 2 to an external FAX device via the phone line 51.

The MFP1 is further provided with a work memory 5, a file memory 6, a compression/expansion controller 7, the aforementioned bus arbiter 8, a CPU 9, and a memory controller PCI bridge 10.

The work memory 5 develops data-to-be-outputted such as the data contained in the print job received by the EtherNet controller 4 from an external device, the data contained in the FAX receive job received by the FAX controller 11 and the image data read by the original reading portion 2, and also stores another data.

The compression/expansion controller 7 of this embodiment is provided with a total of four (4) compressing/expanding devices 71˜74 connected in parallel, and controls these compressing/expanding devices 71˜74 so as to execute the compression of the data-to-be-outputted of a predetermined block size or a page size transmitted from the work memory 5 and the expansion of the compressed data-to-be-outputted read out from the file memory 6.

The file memory 6 stores the data-to-be-outputted compressed by the compressing/expanding devices 71˜74. The stored data will be read out of the file memory 6 to be expanded by the compressing/expanding device 71˜74. The storing of the compressed image in the file memory 6 and the reading thereof are executed based on the control of the compression/expansion controller 7.

The bus arbiter 8 executes the transferring of the data-to-be-outputted to each portion in the MFP in accordance with instructions of a transfer controller 81.

The memory controller PCI bridge 10 controls the work memory 5 and connects the bus of a CPU 9 to the PCI bus.

The CPU 9 executes a control of the entire MFP 1 including the memory controller PCI bridge 10, the transfer controller 81 and the compression/expansion controller 7, and also executes various judgments. For example, the CPU 9 functions as attribute discrimination means for discriminating the attribution of the data of the inputted job transferred to the work memory 5, or discriminates whether the job-to-be-outputted is the first set of print or the second set of print. In this embodiment, the CPU 9 discriminates whether the data is color data or monochrome data as data attribution.

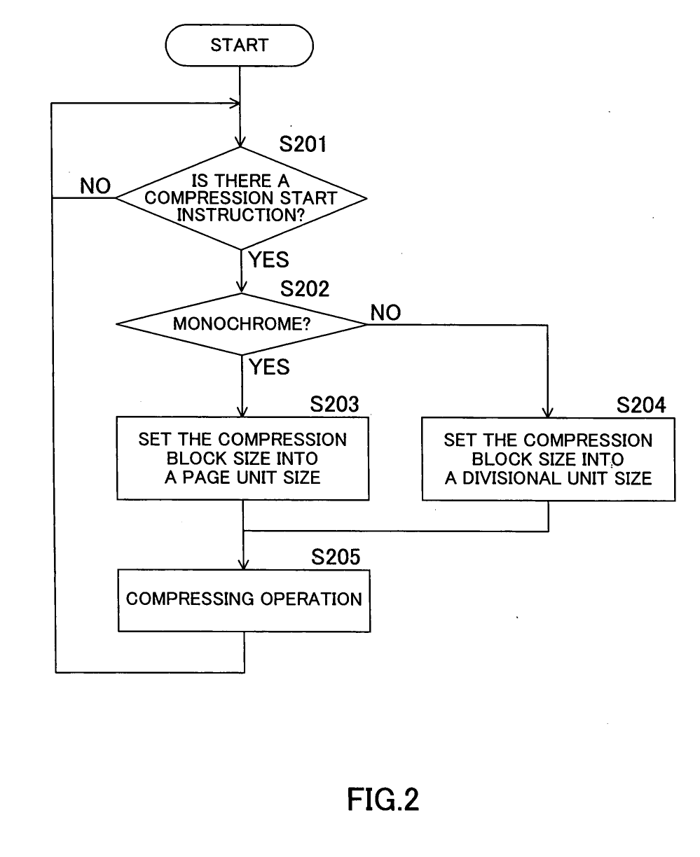

The operation of the MFP1 shown in FIG. 1 from the input to the output regarding the copy job for printing the image data from the original reading portion 2 by the printer portion 3 and the FAX transmission job for transmitting the image data from the original reading portion 2 will be explained with reference to the flowchart of FIG. 2 showing the contents of the data compression processing.

As for the copy job, the explanation will be directed to both the operation of the color print and that of the monochrome print. However, as for the FAX transmission job, the explanation will be directed only to the operation of the monochrome.

In the case where it is recognized in advance that the image data read by the original reading portion 2 is color data or monochrome data and that the image data is monochrome data, the image data read by the original reading portion 2 is transferred to the compressing/expansion controller 7 via the read-image interface 21.

In Step (hereinafter simply referred to as “S”) 201 in FIG. 2, the compression/expansion controller 7 discriminates, for example, whether there is a compression start instruction. If there is no compression start instruction (No in S201), the routine waits for the compressing start instruction. If there is a compressing start instruction (Yes in S201), in S202, it is discriminated whether the data is monochrome data. If it is monochrome data (Yes in S202), in S203, the block size of the data, i.e., the size of the data to be compressed by a single compressing operation, is set into a size of a page unit, and then the routine proceeds to S205.

On the other hand, in S202, if the data is not monochrome data, i.e., color data (No in S202), in S204, the block size is set into a size of a divisional unit which is a size obtained by dividing the size of a page unit by plural numbers, and then proceeds to S205.

In S205, the compressing/expanding devices 71˜74 execute compression operations, then the routine returns to S201 to repeat the aforementioned operations. Thus, in cases where the data is monochrome data, the compression is executed every page unit. On the other hand, in cases where the data is color data, the compression is executed every divisional unit.

The compressed data is stored in the file memory 6 in a state in which a management table is attached to the compressed data. The storing of the data in the file memory 6 is executed every page unit in the case of monochrome data and every divisional unit in the case of color data. Accordingly, in the case of monochrome data having less data per page, it is prevented the entire data amount per page from being increased as compared with the case in which data is divided into divisional units to be compressed and stored, resulting in an increased number of pages that can be stored in the file memory 6. On the other hand, in the case of a color data, the data is compressed and stored every divisional unit, which attains the effective utilization of the plurality of compressing/expanding devices 71˜74.

After completion of the compressing operation, the compressed data is retrieved from the file memory 6 to be expanded by the compressing/expanding devices 71˜74. This expanding operation is executed every page unit in the case of monochrome data and every divisional unit in the case of color data.

In the case of a copy job, the expanded data is transferred to the printer portion 3 via the printer I/F 31 to be printed. In the case of a FAX transmission job, the data is transferred to an external FAX device from the FAX controller 11 via the phone line 51. At the time of transferring the data from the compressing/expanding devices 7 to the printer I/F 31 or the FAX controller 11, the data can be once transferred to the work memory 5 for a buffering operation.

The above explanation is directed to the case in which it can be recognized in advance that the data read by the original reading portion 2 is monochrome data or color data. However, in the case where the attribute of the data is uncertain, the data read by the original reading portion 2 is transferred to the work memory 5 via the read-image interface 21 to discriminate the attribute (color or monochrome) of the data by the CPU 9, and then the data is transferred to the compression/expansion controller 7 to execute the compression.

Next, the processing from the input of the print data from an external device such as a personal computer via the EtherNet 41 to the print thereof by the printer portion 3 will be explained. The contents of the data compression processing performed by the compression/expansion controller 7 can be shown by the same flowchart of FIG. 2.

First, the print data is inputted to the EtherNet controller 4 via the EtherNet 41 and spread in the work memory 5. At this time, the CPU 9 discriminates whether the print data is monochrome data or color data. Thereafter, the print data is transferred to the compression/expansion controller 7 via the work memory 5.

In S201 of FIG. 2, the compression/expression controller 7 discriminates whether there is a compression start instruction from the CPU 9. If there is no compression start instruction (No in S201), the routine waits for the instruction. If there is a compression start instruction (Yes in S201), in S202, it is discriminated based on the discrimination result of the CPU 9 whether the data is monochrome data. In S203, after setting the block size into a size of a page unit, the routine proceeds to S205.

On the other hand, in S202, if the data is not monochrome data, i.e., color data (No in S202), in S204, after setting the block size into a size of a divisional unit which is a size obtained by dividing a size of a page unit by plural numbers, the routine proceeds to S205.

In S205, the compressing operation by the compressing/expanding devices 71-74 is executed, and then the routine returns to S201 to repeat the aforementioned operations. Thus, in cases where the data is monochrome data, the compression is executed every page unit. On the other hand, in cases where the data is color data, the compression is executed every divisional unit.

The compressed data is stored in the file memory 6 in a state in which a management table is attached to the compressed data. The storing of the data in the file memory 6 is executed every page unit in the case of monochrome data and every divisional unit in the case of color data. Accordingly, in the case of monochrome data having less data per page, the number of images/pages that can be stored in the file memory 6 increases.

After completion of the compression operation, the compressed data is retrieved from the file memory 6 and expanded by the compressing/expanding devices 71˜74 every page unit or every divisional unit.

The expanded data is transferred to the printer portion 3 via the printer I/F 31 to be printed. At the time of transferring the data from the compressing/expanding devices 7 to the printer I/F 31, the data can be once transferred to the work memory 5 for a buffering operation.

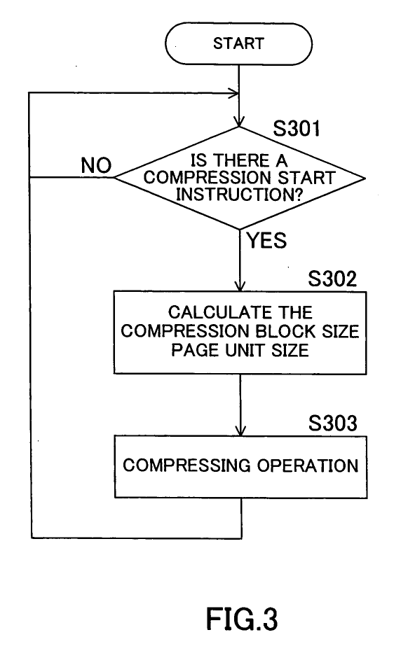

FIG. 3 is a flowchart showing the contents of the data compression processing performed by the compressing/expanding devices 7 according to another embodiment of the present invention.

The flow of the data inputted to the MFP 1 is the same as in each embodiment mentioned above, and different only in compression processing in the compression/expansion controller 7. Accordingly, the following explanation will be mainly directed to this compression processing.

In this embodiment, even in the case of monochrome data, the data is compressed by setting the block size not into a single page unit but into a size having a storing number of images/pages larger than the previously set storing number of images/pages in the file memory 6.

First, in S301, it is discriminated whether there is a compression start instruction from the CPU 9. If there is no compression start instruction (No in S301), the routine waits for the instruction. If there is a compression start instruction (Yes in S301), in S302, it is calculated to obtain a block size having a storing number of images/page larger than the previously set storing number of images/pages in the file memory 6. Then, the block size is set.

Subsequently, in S303, after the compressing operation by the compressing/expanding devices 71-74, the routine proceeds to S301.

Next, the method for setting the block size in S302 will be explained.

The following terminology will be referred to as follows.

A size of an image per page in the direction of a main scanning: “Image Size_X”;

A size of an image per page in the direction of a sub-scanning: “ImageSize_Y”;

A block size in the direction of a main scanning: “BlockSize_X”;

A block size in the direction of a sub-scanning: “BlockSize_Y”;

An array size of the file memory 6: “SizeArray”, wherein the array denotes an area for storing the compressed data of the divided image data, and necessary number thereof will be consumed; and

A standard compression ratio: “CompressRate.”

The data size per page after the compression will be obtained by the following calculation:

[BlockSize_X×BlockSize_Y×the number of colors×CompressRate÷SizeArray (fractions below decimal point will be rounded out)] ×[the divided number], wherein

[the divided number] is [ImageSize_X÷BlockSize_X (fractions below decimal point will be rounded out)] ×[ImageSize_Y÷BlockSize_Y (fractions below decimal point will be rounded out)], and;

[the number of colors] is 4 (four) or 3 (three) in the case of a color, and 1 (one) in the case of a monochrome.

Further, when the size of the management table required to manage the compressed data of a single compression block is referred to as “SizeImageInfo,” the size of the management table per page will be obtained by the following calculation:

SizeImageInfo×[the divided number].

When the size of the memory 6 is referred to as “SizeFileMem”, the predicted value of the storing number will be obtained by the following calculation:

SizeFileMem÷[data size per page after compression+management table size per page].

The block size is set such that the predicted value of this storing number exceeds the predetermined storing number. Such a predetermined storing number is set in advance depending on the attribute of the data, e.g., color or monochrome. Accordingly, depending on the attribute of the data, different size will be set.

According to this embodiment, the number of monochrome data as well as color data to be stored in the file memory 6 can be increased.

Although the preferred embodiments of the present invention was explained above, the present invention is not limited to them. For example, the above explanations were directed to the case in which the attribute of the data is color and monochrome. However, depending whether the data is binary data (corresponding to monochrome data) or multi-valued data (corresponding to a color data), or whether the data is FAX/copy job data (corresponding to color data) or another job data other than the FAX/copy job data (corresponding to a monochrome data), the size of the data to be compressed by a single compressing operation can be set.

Furthermore, the number of the compressing/expanding devices is not limited to 4 (four). The number may be several other than 4 (four), and it may be 1 (one).

While illustrative embodiments of the present invention have been described herein, the present invention is not limited to the various preferred embodiments described herein, but includes any and all embodiments having modifications, omissions, combinations (e.g., of aspects across various embodiments), adaptations and/or alterations as would be appreciated by those in the art based on the present disclosure. The limitations in the claims are to be interpreted broadly based the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited.

What is claimed is:

1. A data processing apparatus, comprising:
a compressor which compresses inputted job data every block into compressed data;
a memory which stores the compressed data every block; and
a controller which sets a size of the block of the data to be compressed every block by said compressor depending on an attribute of the data.

2. The data processing apparatus as recited in claim 1, further comprising an attribute discriminator for discriminating the attribute of the data.

3. The data processing apparatus as recited in claim 1, wherein said controller sets the size of the block depending on the attribute of the data into a size of a page unit or a size of a divisional unit which is a size obtained by dividing the size of the page unit by plural numbers.

4. The data processing apparatus as recited in claim 1, wherein said memory stores the compressed data and a management table, and wherein said controller sets the size of the block based on a total capacity of the compressed data and a management table and a capacity of the memory.

5. The data processing apparatus as recited in claim 1, wherein the data attribute is color or monochrome.

6. The data processing apparatus as recited in claim 1, wherein the attribute of the data is binary data or multi-valued data.

7. The data processing apparatus as recited in claim 1, wherein the attribute of the data is a FAX/copy job or another job than the FAX/copy job.

8. A data processing method, comprising the steps of:
setting a size of a block of data to be compressed every block by a compressor depending of an attribute of the data;
compressing data of an inputted job into the set size of the block by the compressor; and
storing the compressed data into a memory every block.

9. The data processing method as recited in claim 8, further comprising a step of performing attribute discrimination for discriminating the attribute of the data.

10. The data processing method as recited in claim 8, wherein the size of the block is set depending on the attribute of the data into a size of a page unit or a size of a divisional unit which is a size obtained by dividing the size of the page unit by plural numbers.

11. The data processing method as recited in claim 8, wherein the memory stores the compressed data and a management table, and the size of the block is set based on a total capacity of the compressed data and the management table and a capacity of the memory.

12. The data processing method as recited in claim 8, wherein the attribute of the data is color or monochrome.

13. The data processing method as recited in claim 8, wherein the attribute of the data is binary data or multi-valued data.

14. The data processing method as recited in claim 8, wherein the attribute of the data is a FAX/copy hob or another job other than the FAX/copy job.
